(19) United States
(12) Patent Application Publication
(10) Pub. No.: US 2012/0085942 A1
(43) Pub. Date: Apr. 12, 2012

(54) COLLIMATORS AND METHODS FOR MANUFACTURING COLLIMATORS FOR NUCLEAR MEDICINE IMAGING SYSTEMS

(76) Inventors: Yossi Birman, Haifa (IL); Yaron Hefetz, Herzliya (IL)

(21) Appl. No.: 12/901,205

(22) Filed: Oct. 8, 2010

(51) Int. Cl. G21K 1/02; B22F 3/12; B22F 7/00

(52) U.S. Cl. 250/505.1; 419/5

(57) ABSTRACT

Collimators and methods for manufacturing collimators for nuclear medicine (NM) imaging systems are provided. One method includes forming a plurality of collimator segments from powdered tungsten, wherein the plurality of collimator segments have opposing faces with edges therebetween. The method also includes sintering the powdered tungsten segments and joining the plurality of sintered powdered tungsten segments at least at one or more of the edges to form the collimator for the NM imaging system.

### BACKGROUND OF THE INVENTION

The subject matter disclosed herein relates generally to nuclear medicine (NM) imaging systems, and more particularly to methods for manufacturing a collimator for NM imaging systems.

NM imaging systems, for example, Single Photon Emission Computed Tomography (SPECT) and Positron Emission Tomography (PET) imaging systems, use one or more image detectors to acquire image data, such as gamma ray or photon image data. The image detectors may be gamma cameras that acquire two-dimensional views of three-dimensional distributions of emitted radionuclides (from an injected radioisotope) from a patient being imaged.

In order to acquire NM imaging information for a region of interest (ROI), the ROI, such as a heart of a patient, must be positioned within a field-of-view (FOV) of the gamma camera. The gamma cameras also may include collimators for focusing the FOV of the gamma camera. The collimators may create different sizes of FOVs for the gamma camera depending on the configuration of the collimator, which also changes the resolution of the gamma camera.

Collimators for NM imaging may be manufactured from different materials. One common material used to manufacture collimators is lead. Because lead is toxic, the manufacture of collimators using lead can be dangerous, as well as harmful to the environment. Accordingly, special measurements or procedure are used to protect the personnel who are involved in the production of the lead collimators. Moreover, the use of lead is only permitted in a limited number of fields, which is becoming more restrictive and limiting.

Additionally, lead collimators have a lead x-ray fluorescence that can interfere with low energy imaging. For example, when excited with gamma rays of greater than about 80 keV, lead produces x-ray fluorescence at about 70 keV, which interferes with low energy imaging, such as imaging with Americium and Thallium. Thus, this fluorescence can be problematic when imaging dual isotopes such as Technetium and Thallium (Tc+Tl), which results in having to perform multiple scans with a longer total scan time because of the interference. Additionally, registration of the images for the two different scans acquired at different times can be difficult.

### BRIEF DESCRIPTION OF THE INVENTION

In accordance with various embodiments, a method for forming a collimator for detectors of a nuclear medicine (NM) imaging system is provided. The method includes forming a plurality of collimator segments from powdered tungsten, wherein the plurality of collimator segments have opposing faces with edges therebetween. The method also includes sintering the powdered tungsten segments and joining the plurality of sintered powdered tungsten segments at least at one or more of the edges to form the collimator for the NM imaging system.

In accordance with other embodiments, a collimator for a nuclear medicine (NM) imaging detector is provided that includes a plurality of individual powdered metal segments joined together at least at one or more of a plurality of edges between a front face and a rear face of the individual powdered metal segments to form a collimator body. The collimator also includes a plurality of bores extending through the plurality of individual powdered metal segments from the front face to the rear face of the collimator body.

In accordance with yet other embodiments, a collimator for a nuclear medicine (NM) imaging detector is provided that includes a powdered metal collimator body formed from a sintered powdered metal. The collimator also includes a plurality of bores extending through the powdered metal collimator body, wherein the bores have a greater thickness in a center than at ends of the bores.

### BRIEF DESCRIPTION OF THE DRAWINGS

FIG. 1 is a flowchart of a method for manufacturing a collimator in accordance with various embodiments.

FIGS. 2 and 3 are block diagrams illustrating an injection molding process for forming a collimator in accordance with various embodiments.

FIGS. 4 through 7 are block diagrams illustrating a compression molding process for forming a collimator in accordance with various embodiments.

FIG. 8 is a block diagram illustrating forming a collimator from a plurality of segments in accordance with various embodiments.

FIG. 9 is a block diagram illustrating forming a collimator from a plurality of segments in accordance with other various embodiments.

FIGS. 10 through 12 are diagrams illustrating different shaped collimator bores formed in accordance with various embodiments.

FIG. 13 is a diagram illustrating walls of a collimator formed in accordance with one embodiment having a changing thickness.

FIG. 14 is a diagram illustrating walls of a collimator providing less energy blocking than the collimator of FIG. 13.

FIG. 15 is a diagram illustrating forming and releasing parts from a conical mold in accordance with one embodiment.

FIG. 16 is a diagram illustrating a symmetric dual conical mold formed in accordance with one embodiment.

FIG. 17 is a top perspective view of a gamma camera including a plurality of pixelated photon detectors.

FIG. 18 is a top plan view illustrating pixels of the pixelated photon detectors of the gamma camera of FIG. 17.

FIG. 19 is a schematic illustration of a nuclear medicine (NM) imaging system having collimators constructed in accordance with one embodiment.

### DETAILED DESCRIPTION OF THE INVENTION

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide systems and methods for manufacturing or forming a collimator, particularly a collimator for a nuclear medicine (NM) imaging system, such as a registered collimator. For example, a collimator formed in accordance with various embodiments may be used in combination with an NM imaging system having Cadmium Zinc Telluride (CZT) gamma cameras or detectors. By practicing various embodiments, collimators having a larger size and more complex geometries may be formed with increased repeatability of geometric accuracy, which may result in a reduced variance in the dimensions of bores of a registered collimator. In some embodiments, the manufacture or formation of the collimator is an automated process (e.g., an automated powder sintering process). However, some or all of the steps may be performed manually.

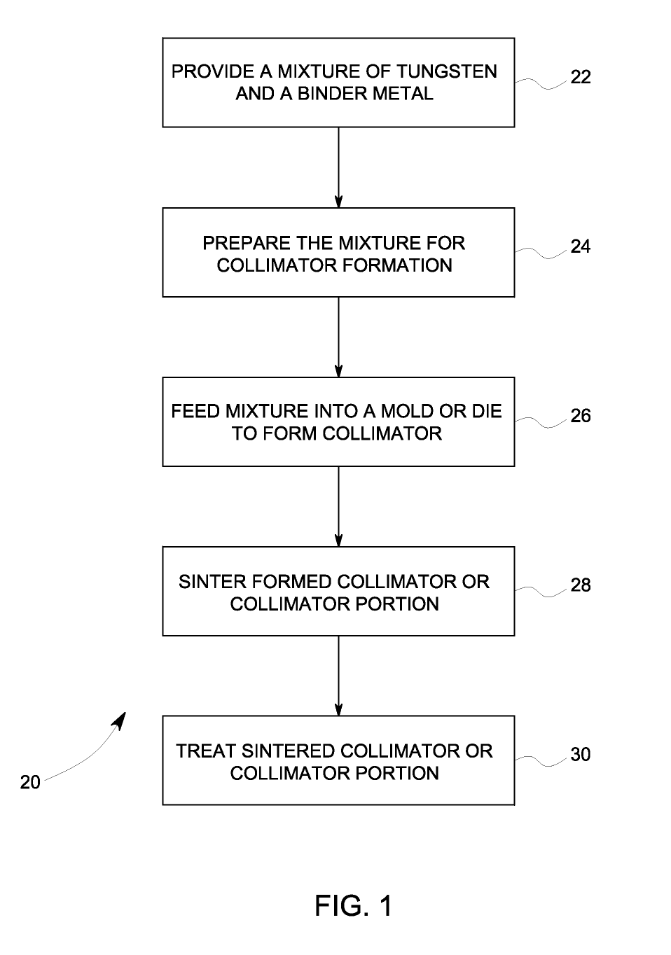

Specifically, various embodiments provide a method 20 as illustrated in FIG. 1 for manufacturing a collimator, for example, a registered collimator for an NM imaging system. It should be noted that although the method 20 is described using a sintered tungsten powder to form the collimator, the various embodiments may be implemented using other materials and different formation processes to form all or a portion of the collimator. For example, the various embodiments may be implemented using a transition series and/or heavy metal. Additionally, the process to form the collimator may include, for example, using a die with compressed tungsten powder or a metal injection molding process as described in more detail below.

In particular, the method 20 includes providing a powder (or liquidate) raw material, which in the below described embodiment is a tungsten mixture that includes a tungsten powder of combined metal particles. For example, the raw material may be a mixture of metal powder (e.g., tungsten powder) with organic binders, such as wax, thermoplastic resins or other suitable materials, which are used to injection mold the collimator. In other embodiments, a mixture or composition containing a tungsten based material such as a tungsten carbide and a binder metal together form the metal powder composition. The binder metal may be different types of suitable metal, for example, nickel, which may reduce the friction of the powder and allow increased compression when using a compression process within a die.

Thereafter, the mixture may be prepared at 24 for use in collimator formation. For example, when performing an injection molding process, the tungsten powder and organic binders may be mixed in a heated state until a homogeneous mixture is obtained. After cooling the mixture, the mixture is granulated to allow the mixture to be fed into an injection molding machine. It should be noted that the granulated mixture may be stored, if desired or needed, before the injection molding is performed. The granulated mixture in various embodiments acquires plastic-like characteristic for injecting in a mold. In other embodiments, such as when compressed powder is used in a die for forming the collimator, no additional preparation may be needed, or may include a simple mixing process to form the composition.

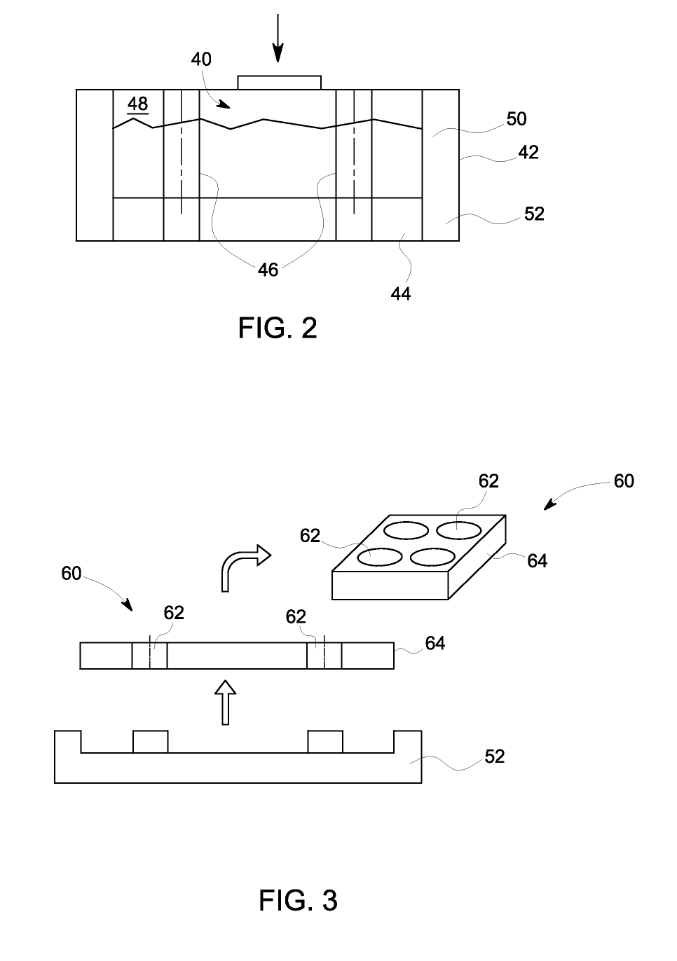

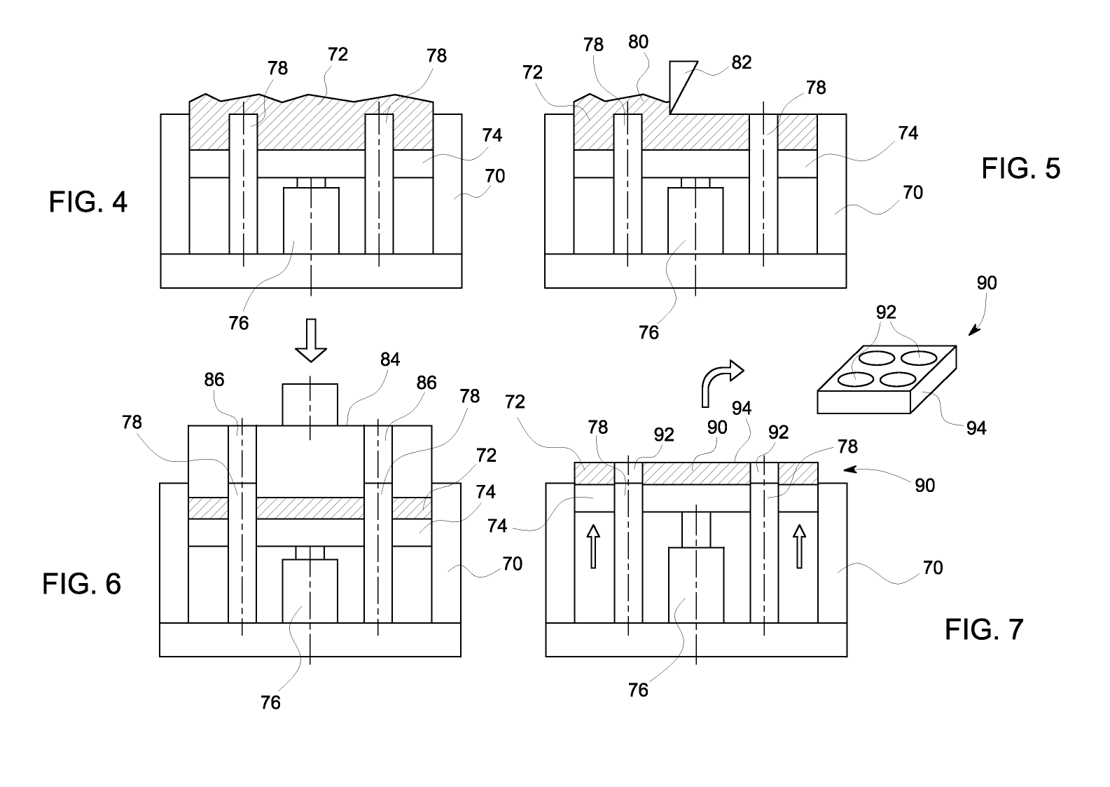

The prepared mixture is then fed into a mold or die to form the collimator or a portion thereof, such as multiple segments. For example, FIGS. 2 and 3 illustrate a metal injection molding process using the prepared mixture. FIGS. 4 through 7 illustrate collimator formation using a compressed powder in a die. It should be noted that the mold or die is sized and shaped based on, for example, the type and requirements of the collimator or imaging detectors for the NM imaging on which the collimators are to be used. In various embodiments, the mold or die is configured to form a portion of the collimator and not the entire collimator, for example, about one-half, one-third, one-quarter, etc. of the collimator. However, in other embodiments, the mold or die may be configured to form the entire collimator, such as for attaching to a single gamma camera of an NM imaging system.

Thus, as shown in FIG. 2, for an injection molding process, a powder mixture 40 is injected into a mold 42 (illustrated by the arrow) using any suitable injection process for molding. A base 44 of the mold 42 includes an array of protrusions 46, for example, a plurality of protruding pins or columns that are sized and shaped according to the bore size and shape requirements for the fabricated collimator (e.g., round, hexagonal, etc.). As illustrated, a granulated tungsten mixture, for example, having plastic-like characteristics is injected to fill the mold 42, which is illustrated as partially filled. The process includes completely filling the mold 42 in various embodiments.

The granulated tungsten mixture, which is hearted, cools and hardens in the mold 42. In particular, the granulated tungsten mixture hardens to the configuration of the cavity 48 of the mold 42, which includes the protrusions 46 that define bores through the hardened granulated tungsten mixture. Thereafter, a debinding process may be performed to remove the organic binders.

The powdered metal collimator then may be removed from the mold 42 as illustrated in FIG. 3, for example, by opening the mold 42 along a separation area, which may have been held together by a clamp or other suitable mechanism. For example, the mold 42 may be formed from two mold halves 50 and 52 (only one mold half 52 is shown in FIG. 3) that define the collimator or collimator portion, such as a top half and a bottom half.

As shown in FIG. 3, the formed collimator 60, or a portion thereof (which is illustrated in FIG. 3), is removed from the mold 42, for example, by opening the mold 42 by separating the mold halves 50 and 52. It should be noted that the portion of the collimator 60 is shown in FIG. 3 in both side elevation and perspective views and illustrates the bores 62 formed through the body 64 of the collimator 60.

For a compression molding process, as illustrated in FIGS. 4 through 6, a powder mixture 72 is poured and/or spread into a die 70. For example, a powder (or liquidate) of combined metals, such as tungsten and binder mixture is poured into the die 70. The powder mixture 72 is poured into the die 70 such that the entire cavity of the die 70 to be used to form the collimator is at least filled. It should be noted that a base 74 of the die 70 may be raised or lowered, such as, based on the dimensions or thickness of the collimator to be produced. The base 74 may be moved using one or more supporting members 76, for example, a supporting jack that may be powered by any suitable means (e.g., hydraulic, electromechanical, etc).

The base 74 of the die 70 includes an array of protrusions 78, for example, a plurality of protruding pins or columns that are sized and shaped according to the bore size and shape requirements for the fabricated collimator (e.g., round, hexagonal, etc.). The protrusions 78 may extend from below the base 74, and through the base 74 to the top of the die 70, such that the different thickness collimators may be formed using the same die 70.

As illustrated in FIG. 5, the powder mixture 72 may overfill the die 70. The excessive powder 80 is removed off the die 70 using, for example, a sweeping member 82 that may include a generally rigid planar surface to create a generally planar top layer of powder mixture 72. Thereafter, a pressing block 84 as illustrated in FIG. 6 is used to compress and/or apply a force to the powder mixture 72, to compact the powder mixture 72 within the die 70. The pressing block 84 may be any suitable device for pressing the powder mixture 72 into the die 70 to form the collimator. It should be noted that the powder mixture 72 may be compressed such that a top of the powder mixture 72 is below at top edge of the die 70. It also should be noted that the pressing block 84 includes openings 86 therethrough for receiving the protrusions 78 as the powder mixture 72 is compressed. Thus, the pressing block 84 has an array of cut-outs that correspond to the array of protrusions 78 that will form the bores of the collimator.

Additionally, the pressing block 84 may be manually powered or automatically powered, which may include use of a motorized controller or actuator. It should be noted that the amount of powder mixture 72 (e.g., the volume of powder), the amount of pressure applied, the temperature of the die 70 and/or powder mixture 72, etc. may be varied. For example, one or more of these factors may be varied based on the composition of the powder mixture 72 of the desired or required properties of the final collimator.

Thereafter, once the powder mixture 72 is suitably compressed, the pressing block 84 is raised and removed as illustrated in FIG. 7. The supporting member(s) 76 are then operated to extend and eject the pressed collimator 90, or a portion thereof (which is illustrated in FIG. 7), from the die 70. It should be noted that the portion of the collimator 90 is shown in FIG. 7 in both side elevation and perspective views and illustrates the bores 92 formed through the body 94 of the collimator.

Referring again to FIG. 1, after the collimator body, which may be a portion of the collimator (or the entire collimator) is formed, the body is sintered at 28. For example, the die formed or pressed collimator body may be sintered using any suitable sintering process, which may be based on the desired or required properties of the final collimator. In various embodiments, the collimator body may be placed in a sintering oven, for example, at 900 degrees Celsius to melt and bond the tungsten together. However, it should be noted that the collimator body may be sintered at different temperatures, and 900 degrees is a non-limiting example. In general, the sintering process, including the temperature of the sintering, the period of time of sintering, the protective atmosphere (e.g., vacuum, noble gas, mixture of noble gases, hydrogen gas, etc.) are selected as desired or needed, such as based on the desired or required properties or characteristics (e.g., operating characteristics) for the collimator. In some embodiments, the sintering may cause shrinking of the collimator to a desired or required dimension and/or density.

The sintered collimator may be additionally treated at 30. For example, the sintered collimator may be heat treated or undergo other surface procedures or treatments, such that a completed collimator that is ready for assembly is provided. It also should be noted that cooling procedures may be performed between any one or more of the steps of the method 20.

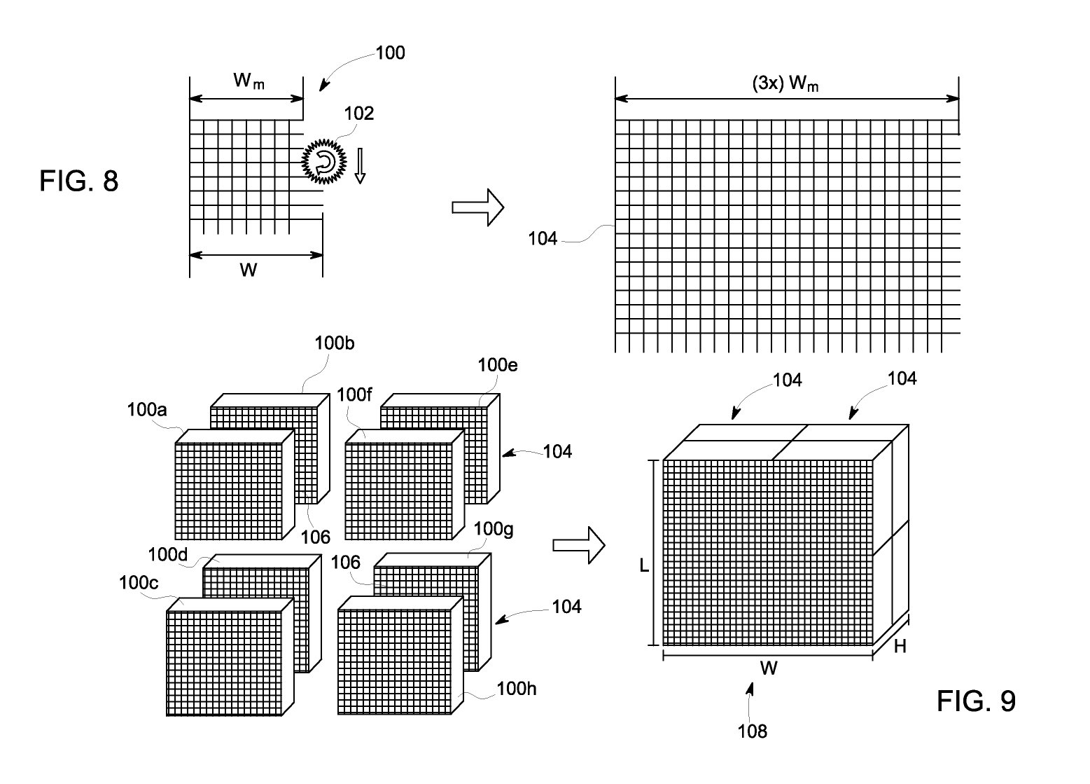

The complete collimator may be formed from a plurality of body portions or segments as illustrated in FIGS. 8 and 9. Thus, as described above, the collimator body may be formed by one or more elements, such as a combined collimator core and framing, a collimator core only, a segment or portion of a collimator core, or a single elementary tube (e.g., a single bore structure) from which the core is comprised. For example, by practicing some embodiments, different portions of the collimator bore may be formed that are coupled together, which may reduce the pitch between adjacent holes of the collimator geometry

In some embodiments, as illustrated in FIG. 8, the portion or segment 100 of the collimator body that is formed from powdered metal may be “over-sized” and then machined (e.g., grind, milled, etc.) down to the dimensions in one or more directions or otherwise finished for forming the complete collimator. FIG. 8 is a simplified block diagram illustrating the use of a machining tool 102, which may be any type of cutting tool, for example. The machining tool 102 is used to machine one or more sides (or portions thereof) of the collimator segment 100, such as from a formed width (W) to a machined width (Wm) for use in constructing the complete collimator, for example, the collimator core. As illustrated in FIG. 8, multiple machined segments 100 are joined together to formed a combined collimator body 103, which is illustrated as a combination in the width direction of three segments 100. However, one or more segments 100 may be joined the in width, height or length directions of the collimator as illustrated in FIG. 9 and described in more detail below. Accordingly, lengthwise, widthwise and/or heightwise segments may be joined or combined. It should be noted that the combined collimator body 103 also may be machined, such as along one or more edges (or portions thereof). Additionally, the segments 100 may be joined using any suitable means, such as glue, epoxy, any type of adhesive, etc. As other examples, the segments 100 may be joined using ultrasonic welding, arc welding, brazing, sensitization and soldering, among others. It also should be noted that other joining or fastening members may be used, such as a frame, for example.

Collimators used with pixilated detector (such as a solid-state detector, for example CZT or CdTe or others) are preferably accurately registered to the detector pixels. Registration enables improved resolution where each detector views the object through one collimator bore. Additionally, accurate registration allows placing the septa of the collimator above the insensitive gap between detector's pixels, blocking (at least partially) gamma radiation from impinging on these gaps. This reduces the sensitivity loss as gamma losses of septa and gaps overlap. Sintering and other manufacturing processes (e.g. solidification of epoxy resins) may cause small size distortion (typically shrinkage). Although the distortion can be largely compensated by choosing the size of the mold, there may be some small distortion variations from one batch to another. Even a fraction of a percent, for example 0.2% of size variation, when present in a large piece such as a 50 cm can cause a 1 mm miss-registration of the last bore versus the corresponding last pixel. This would result in a gross miss-registration since a typical detector pixel may be about 2.5 mm. By dividing the collimator into multiple parts, for example, 10 parts, 5×5 cm in size, each part may be grinded to exact dimensions and then glued or joined together to form a perfectly, or at least sufficiently accurately registered collimator. Optionally, only pieces that were found to be larger than a certain threshold size are machined. Still optionally, pieces may be selected according to size such that the combination of pieces would yield a sufficiently accurately registered collimator. Further optionally some gaps between adjacent collimator pieces are left when forming the large collimator in order to achieve a sufficiently accurately registered collimator.

As illustrated in FIG. 9, multiple segments 100a-100h may be adhered along the edges 104 or faces 106 to form the three-dimensional body or core of the collimator. For example, the height, width and/or thickness of the collimator may be formed from different segments 100, such that a collimator core 108 is provided. For example, a plurality of segments 100 may be joined together to form a 40 centimeter by 40 centimeter powdered metal collimator. In some embodiments, the segments 100 are joined only at one or more edges 104 of the segments 100. In other embodiments, the segments 100 may be joined at one or more edges 104 and at one or more faces 106. In still other embodiments, the segments may be joined only at one or more faces 106 of the segments 100. Additionally, for each of the segments 100, different ones of the edges 104 and/or faces 106 may be joined to different ones of the edges 104 and/or faces 106 of other segments 100. Thus, as shown in FIG. 9, the length (L), width (W) and/or height (H), which is also a thickness, may be formed and/or defined by one or more portions, for example, one or more edges 104 and/or faces 106 of one or more of the segments 100.

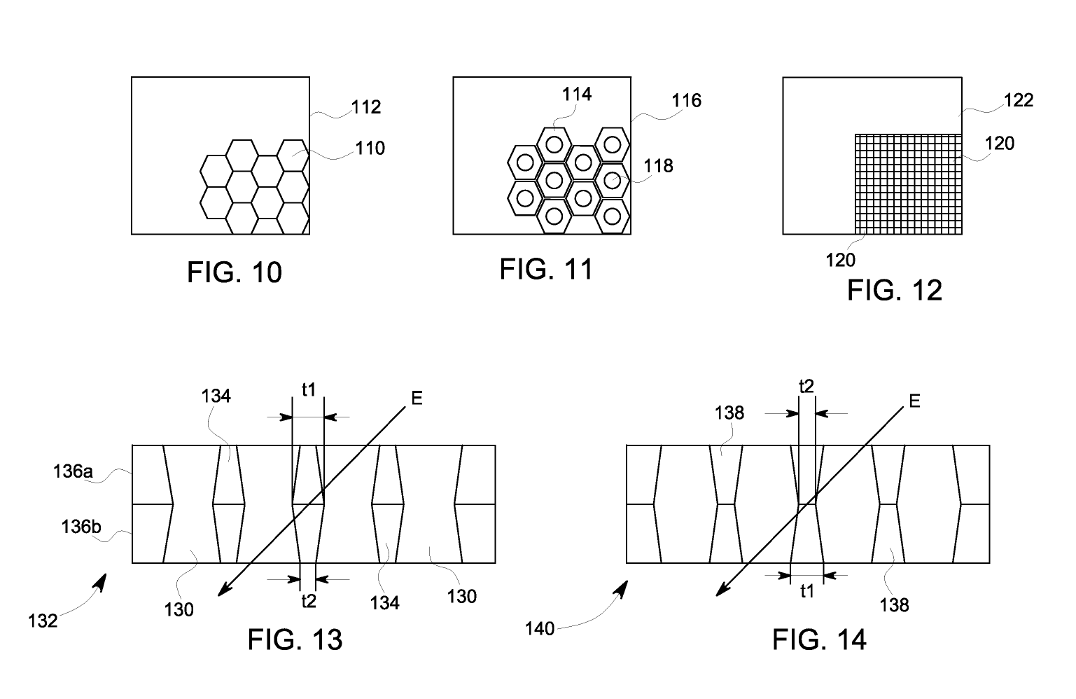

It should be noted that the bores formed as part of the collimator using the various embodiments, may have different shapes and sizes. For example, as shown in FIG. 10, the cross-sectional shape of the bores 110 of a collimator 112 may be hexagonal, which also illustrates a portion or segment of the collimator 112 formed by various embodiments. In other embodiments, the cross-sectional shape of the bores 114 of a collimator 116 may be hexagonal walled with circular openings 118 as illustrated in FIG. 11. As another example, the cross-sectional shape of the bores 120 of a collimator 122 may be square (or rectangular) as illustrated in FIG. 12. It should be noted that any cross-sectional shape may be provided, such as circular, triangular, etc.

In various embodiments, the thickness of the bores of the collimator are not constant along an axial direction as illustrated in FIG. 13. For example, the bores 130 of a collimator 132 may be formed such that a thickness (t1) at a center of the bore 130 is thicker than a thickness (t2) at each of the ends of the bore 130. For example, the bore 130 may have dual conical (trapeze like) shape such that the thickness of the walls 134 (septa) is wider at the center than at the ends. It should be noted that although the walls 134 are illustrated as having a constant taper, the taper or slant may be varied or changed as desired or needed. It also should be noted that the collimator 132 is formed from at least two segments 136a and 136b, which correspond to a top portion and bottom portion, or vice versa. The length and width of the collimator 132 also may be formed from multiple segments as described herein. In the configuration of FIG. 13, the collimator construction allows the blocking of more intense energy E (e.g., gamma photons) than a configuration where walls 138 are thicker at the ends than at the center as illustrated in the collimator of FIG. 14 or a collimator with even thickness septa with septa thickness of t2. By choosing t1 to be thick enough to reduce septa penetration to an acceptable level, it is possible to choose t2 to be approximately ½ of t1 without substantially increasing the septa penetration. Thinning the edges (t2) of the collimator increases the sensitivity of the collimator with only slight reduction of resolution (which may be compensated by making the collimator slightly taller). In all, a collimator having the shape illustrated in FIG. 13 may have a better sensitivity/resolution/penetration performance than a parallel septa design (or design as illustrated in FIG. 14).

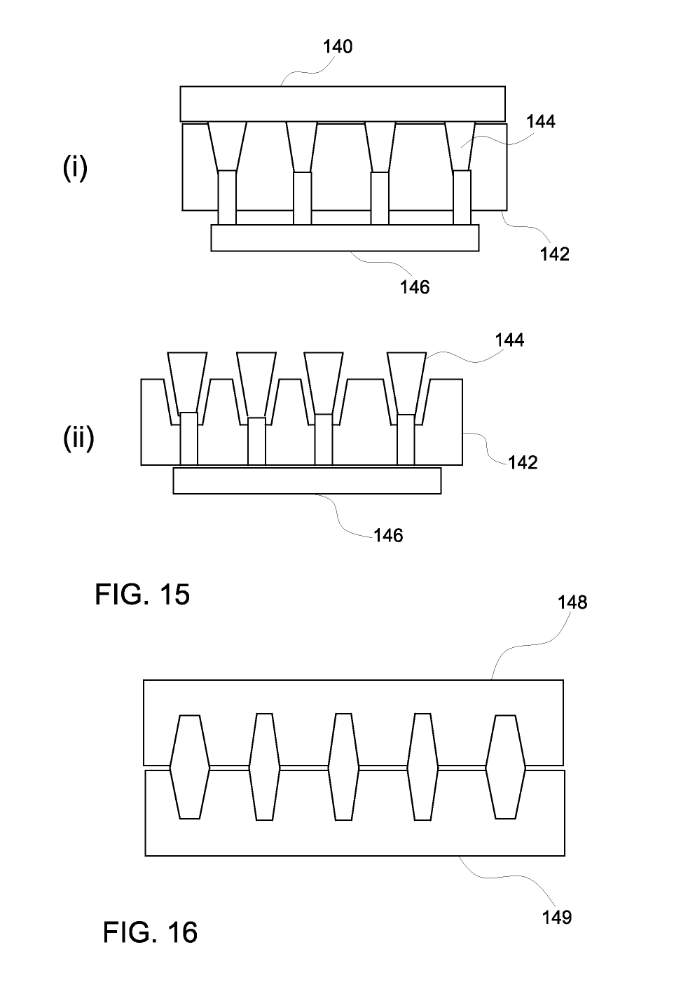

Additionally, a manufacturing process of conical bores may be easier as it is easier to release a part from the mold within that is conical in shape. For example, as illustrated in FIG. 15 (i) and (ii) showing respectively the mold formed form mold parts, for example, mold segments 140 and 142, and the formed parts 144 (e.g., collimator sections); and the releasing of the parts 144 parts for a conical mold. It should be noted that a part removing device 146 (e.g., a pushing device) is used to exert a force to release the parts 144 from the mold segment 142. As another example, FIG. 16 illustrates a mold formed from mold segments 148 and 149 wherein the mold is a symmetric dual conical mold.

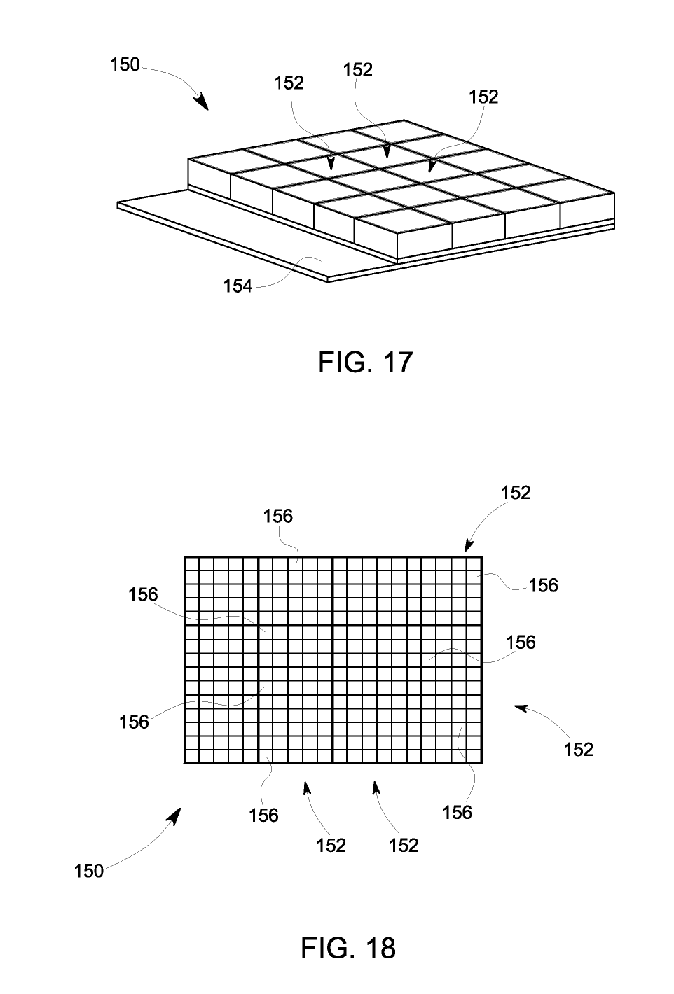

The bores generally correspond to pixels of a NM detector (e.g., gamma camera) upon which the collimator is to be mounted, such that the collimator is a registered collimator having one bore corresponding to each pixel of the NM detector, for example, a gamma camera 150 as illustrated in FIG. 17. The gamma camera 150 may be configured as a semiconductor photon detector, and in various embodiments may be formed from CZT or Cadmium Telluride (CdTe), among other materials. The gamma camera 150 may be rectangular shaped as illustrated in FIG. 17, or may be formed in different shapes. The gamma camera 150 is formed from a plurality of pixelated detectors 152, for example, twenty pixelated detectors 152 arranged to form a rectangular array of five rows of four detectors 152. The pixelated detectors 152 are shown mounted on a motherboard 154. Gamma cameras having larger or smaller arrays of pixelated detectors 152 also may be provided.

The pixelated detectors 152 may be configured to acquire, for example, Single Photon Emission Computed Tomography (SPECT) image data. Thus, a plurality of pixilated detectors 152 (illustrated as modules) may be provided, each having a plurality of pixels 156 as shown in FIG. 18 and forming the gamma camera 150. In various embodiments, the gamma camera 150 is fitted with a collimator formed in accordance with various embodiments. For example, a registered collimator formed in accordance with various embodiments may be mounted to a front face or surface of the gamma camera 150 as illustrated in FIG. 18.

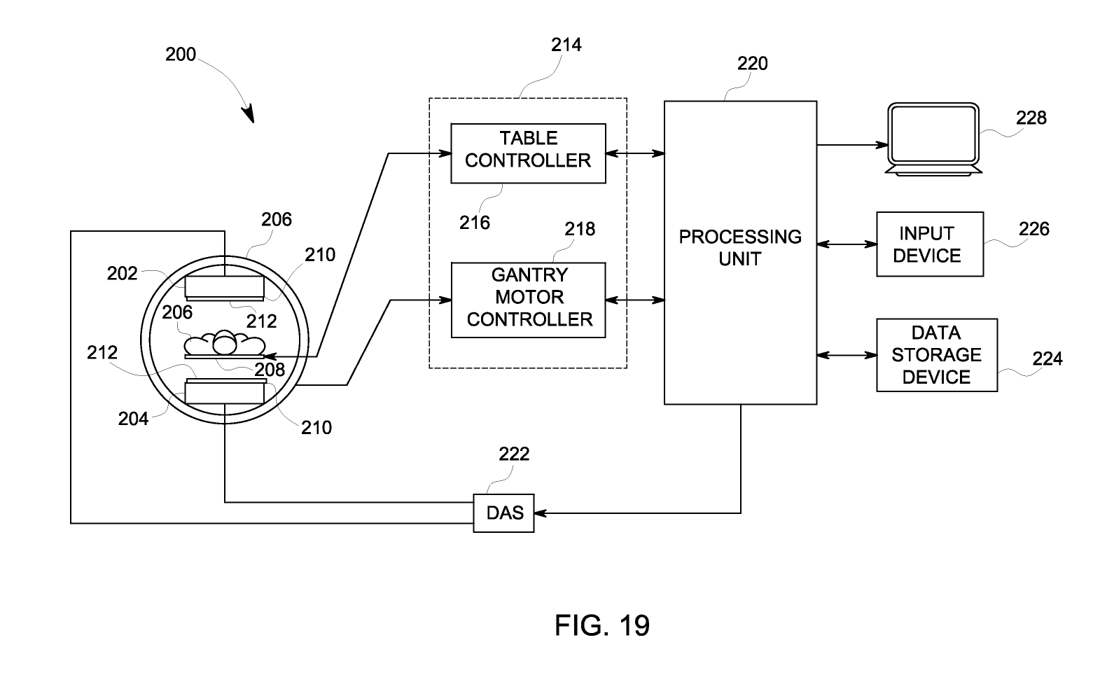

FIG. 19 is a schematic illustration of an NM imaging system 200 having collimators formed in accordance with various embodiments. The NM imaging system 200 includes two gamma cameras 202 and 204 mounted to a gantry 207. The gamma cameras 202 and 204 are each sized to enable the system 200 to image a portion or all of a width of a patient 206 supported on a patient table 208. Each of the gamma cameras 202 and 204 in one embodiment are stationary, with each viewing the patient 206 from one particular direction. However, the gamma cameras 202 and 204 may also rotate about the gantry 207. The gamma cameras 202 and 204 have a radiation detection face 210 that is directed towards, for example, the patient 206. The detection face 210 of the gamma cameras 202 and 204 are covered by a collimator 212 formed in accordance with one or more embodiments as described herein, which may be formed from a powdered metal collimator body or core. The collimator 212 may have different shapes and configurations, for example, the shapes of the bores may be different as described herein.

The system 200 also includes a controller unit 214 to control the movement and positioning of the patient table 208, the gantry 207 and/or the gamma cameras 202 and 204 with respect to each other to position the desired anatomy of the patient 206 within the field of views (FOVs) of the gamma cameras 202 and 204 prior to acquiring an image of the anatomy of interest. The controller unit 214 may include a table controller 216 and a gantry motor controller 218 that may be automatically commanded by a processing unit 220, manually controlled by an operator, or a combination thereof. The gantry motor controller 218 may move the gamma cameras 202 and 204 with respect to the patient 206 individually, in segments or simultaneously in a fixed relationship to one another. The table controller 216 may move the patient table 208 to position the patient 206 relative to the FOV of the gamma cameras 202 and 204.

In one embodiment, the gamma cameras 202 and 204 remain stationary after being initially positioned, and imaging data is acquired and processed as discussed below. The imaging data may be combined and reconstructed into a composite image, which may comprise two-dimensional (2D) images, a three-dimensional (3D) volume or a 3D volume over time (4D).

A Data Acquisition System (DAS) 222 receives analog and/or digital electrical signal data produced by the gamma cameras 202 and 204 and decodes the data for subsequent processing. An image reconstruction processor, which may form part of the processing unit 220, receives the data from the DAS 222 and reconstructs an image of the patient 206. A data storage device 224 may be provided to store data from the DAS 222 or reconstructed image data. An input device 226 (e.g., user console) also may be provided to receive user inputs and a display 228 may be provided to display reconstructed images.

In operation, the patient 206 may be injected with a radiopharmaceutical. A radiopharmaceutical is a substance that emits photons at one or more energy levels. While moving through the patient's blood stream, the radiopharmaceutical becomes concentrated in an organ to be imaged. By measuring the intensity of the photons emitted from the organ, organ characteristics, including irregularities, can be identified. The image reconstruction processor receives the signals and digitally stores corresponding information as an M by N array of pixels. The values of M and N may be, for example 64 or 128 pixels across the two dimensions of the image. Together the array of pixel information is used by the image reconstruction processor to form emission images.

Thus, various embodiments provide a powdered metal collimator. The collimator may be formed from a plurality of segments to create the core of the collimator.

Various embodiments may be provided in connection with systems implemented in hardware, software or a combination thereof. The various embodiments and/or components, for example, the collimator may be implemented in connection with a system having modules, or components and controllers therein, which also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for forming a collimator for detectors of a nuclear medicine (NM) imaging system, the method comprising:
forming a plurality of collimator segments from powdered tungsten, the plurality of collimator segments having opposing faces with edges therebetween;
sintering the powdered tungsten segments; and
joining the plurality of sintered powdered tungsten segments at least at one or more of the edges to form the collimator for the NM imaging system.

2. A method in accordance with claim 1 wherein the plurality of collimator segments have a dimension defined by a length, width and thickness, and further comprising machining at least one of the length, width or thickness to reduce the dimension of the plurality of collimator segments.

3. A method in accordance with claim 1 further comprising forming walls of bores of the collimator having a greater thickness in a center than at ends of the bores of the collimator.

4. A method in accordance with claim 1 further comprising forming walls of bores of the collimator having a dual conical cross-section.

5. A method in accordance with claim 1 wherein the forming comprises injection molding the plurality of collimator segments using a mixture of metal powder and binders.

6. A method in accordance with claim 1 wherein the forming comprises compression molding the plurality of collimator segments using a mixture of metal powder and binders.

7. A method in accordance with claim 1 wherein the plurality of collimator segments comprise top and bottom collimator portions and wherein the opposing faces of the plurality of collimator segments are joined together.

8. A method in accordance with claim 1 wherein the plurality of collimator segments comprise over-sized segments and further comprising machining down the over-sized segments.

9. A method in accordance with claim 1 further comprising forming the plurality of collimator segments from a plurality of powdered metal formed single bore structures.

10. A collimator for a nuclear medicine (NM) imaging detector, the collimator comprising:
a plurality of individual powdered metal segments joined together at least at one or more of a plurality of edges between a front face and a rear face of the individual powdered metal segments to form a collimator body; and
a plurality of bores extending through the plurality of individual powdered metal segments from the front face to the rear face of the collimator body.

11. A collimator in accordance with claim 10 wherein the plurality of individual powdered metal segments are formed from a sintered tungsten powder.

12. A collimator in accordance with claim 10 wherein the bores have a greater thickness in a center than at ends of the bores.

13. A collimator in accordance with claim 10 wherein the bores have a dual-conical cross-section.

14. A collimator in accordance with claim 10 wherein the plurality of individual powdered metal segments comprises lengthwise, widthwise and heightwise portions forming the collimator body.

15. A collimator in accordance with claim 10 wherein the plurality of individual powdered metal segments comprise machined edges joining the segments.

16. A collimator for a nuclear medicine (NM) imaging detector, the collimator comprising:
a powdered metal collimator body formed from a sintered powdered metal; and
a plurality of bores extending through the powdered metal collimator body, wherein the bores have a greater thickness in a center than at ends of the bores.

17. A collimator in accordance with claim 16 wherein the bores have a dual-conical cross-section.

18. A collimator in accordance with claim 16 further comprising a plurality of individual powdered metal segments joined together at least at one edge of the plurality of individual powdered metal segments to form the powdered metal collimator body.

19. A collimator in accordance with claim 16 wherein the sintered powdered metal comprises a sintered powdered tungsten.

20. A collimator in accordance with claim 16 wherein a change in thickness of the bores is tapered.
